(19) United States
(12) Patent Application Publication
(10) Pub. No.: US 2021/0396387 A1
(43) Pub. Date: Dec. 23, 2021

(54) DEVICE FOR EXTINGUISHING BIRTHDAY CANDLES

(71) Applicant: MACH 33 VENTURES LLC, HENRICO, VA (US)

(72) Inventors: MARK REINHARDT APELT, HENRICO, VA (US); MARK EDWARD LAREAU, HENRICO, VA (US)

(21) Appl. No.: 17/346,225

(22) Filed: Jun. 12, 2021

Related U.S. Application Data
(60) Provisional application No. 63/102,629, filed on Jun. 22, 2020.

(51) Int. Cl. F23Q 25/00; G10K 15/04

(52) U.S. Cl. CPC F23Q 25/00; G10K 15/04

(57) ABSTRACT

A device for extinguishing birthday candles comprises a housing, a selectively operable fan adapted to propel ambient air away from the device, and a pressure switch electrically connected to the fan such that the fan operates when the pressure switch is activated. The housing defines an air chamber and an air inlet. The air chamber is adapted to receive exhaled breath from a user via the air inlet. The pressure switch is adapted to be activated by the exhaled breath such that the exhaled breath causes the fan to operate.

### CROSS-REFERENCE TO RELATED APPLICATIONS

This application claims priority to pending U.S. Provisional Application Ser. No. 63/102,629, filed Jun. 22, 2020, the contents of which are incorporated herein by reference in its entirety.

### FIELD OF THE INVENTION

The present technology relates generally to devices for extinguishing candles.

### BACKGROUND

In many Western countries, a common birthday tradition is to light a candle on a cake, and then have the celebrant blow out that candle. While this is a festive tradition, it is unsanitary. In its May 2017 issue, The Journal of Food Research identified that blowing out a birthday candle increases the incidence of cake-top bacteria by 1400%.

### BRIEF SUMMARY OF THE DISCLOSURE

In one embodiment of the invention, a device for extinguishing birthday candles comprises a housing, a selectively operable fan at least partially positioned within the housing and adapted to propel ambient air away from the device, and a pressure switch positioned within the housing and electrically connected to the fan such that the fan operates when the pressure switch is activated. The housing defines an air chamber and an air inlet. The air chamber is adapted to receive exhaled breath from a user via the air inlet. The pressure switch is adapted to be activated by the exhaled breath such that the exhaled breath causes the fan to operate.

The pressure switch may be positioned within the air chamber.

The housing may define an air outlet adapted to exhaust the exhaled breath from the air chamber. The air outlet may be adapted to exhaust the exhaled breath from the air chamber at an angle relative to the propelled ambient air. The air outlet may be adapted to exhaust the exhaled breath from the air chamber in a direction opposite that of the propelled ambient air. The air outlet may be is adapted to exhaust the exhaled breath from the air chamber in a direction toward the user.

The fan may comprise at least one rotatable fan blade and a motor connected to the at least one rotatable fan blade such that the at least one rotatable fan blade rotates when the motor is activated. The at least one rotatable fan blade may be external to the housing.

The housing may be elongated. The housing may be generally tubular.

The device may further comprise a noisemaker adapted to selectively emit a noise when the exhaled breath is received in the air chamber. The noisemaker may be mechanical or electronic.

The device may further comprise a light adapted to selectively emit light when the exhaled breath is received in the air chamber. The light may comprise at least one light emitting diode.

### BRIEF DESCRIPTION OF THE SEVERAL VIEWS OF THE DRAWINGS

Reference will now be made to the accompanying drawings, which are not necessarily drawn to scale. The following detailed description of the disclosure will be better understood when read in conjunction with the appended drawings. It should be understood, however, that the disclosure is not limited to the precise arrangements and instrumentalities shown. In the drawings:

FIG. 1 is a perspective view of a device for extinguishing birthday candles, in accordance with embodiments of the invention.

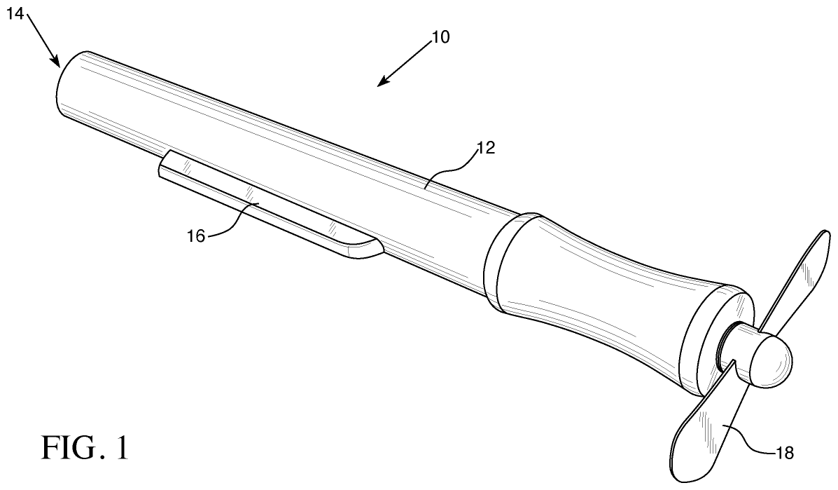

FIG. 2 is a perspective view of the device of FIG. 1, in operation.

FIG. 3 is an exploded perspective view of the device of FIG. 1.

FIG. 4 is a block diagram of the electrical components of the device of FIG. 1.

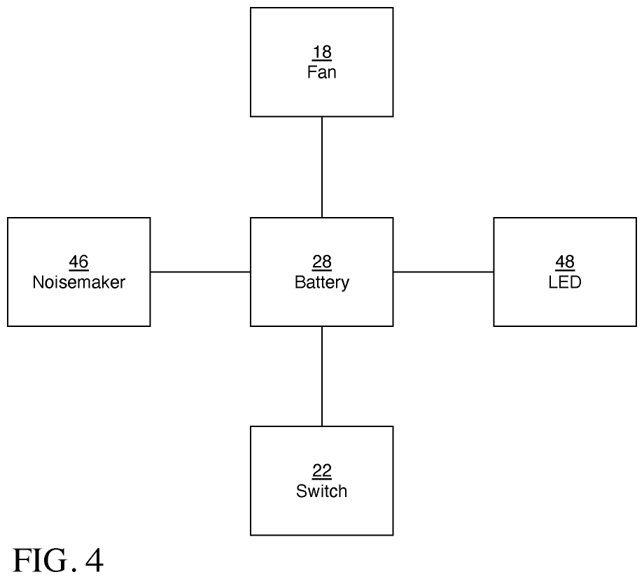

### DETAILED DESCRIPTION OF THE DISCLOSURE

Certain terminology is used in the following description for convenience only and is not limiting. The words “lower,” “bottom,” “upper,” “top,” “left” and “right” and the like designate directions in the drawings to which reference is made. The words “inwardly,” “outwardly,” “upwardly” and “downwardly” and the like refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Embodiments of the invention are directed to a breath-activated device that mechanically propels clean air towards one or more candles on a birthday cake while directing exhaled air, and its accompanying germs, away from the cake. In one embodiment of the present invention, a breath-actuated switch initiates a fan to extinguish a birthday candle, while the exhaled air is routed by the device away from the cake, so as to simulate the experience of blowing out candles without spreading germs upon the cake.

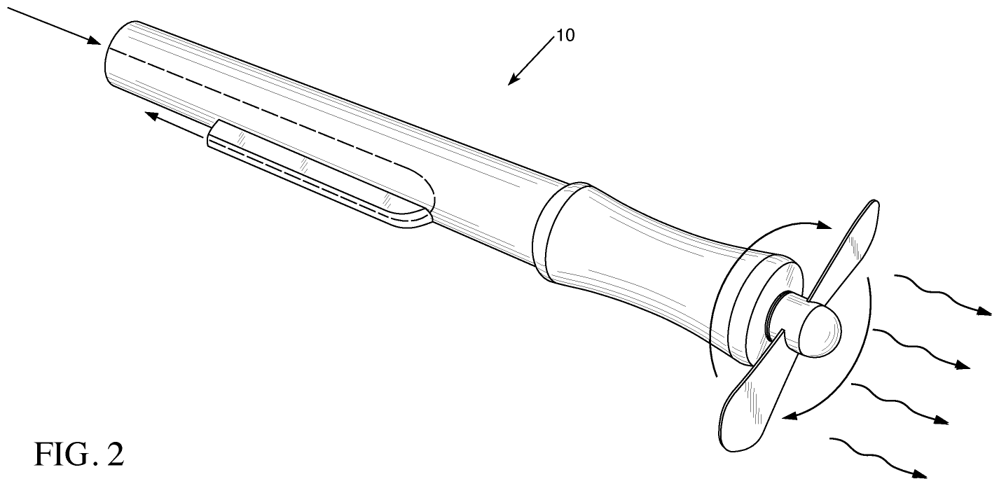

Referring now to the figures, a device 10 for extinguishing birthday candles is illustrated in accordance with embodiments of the invention. The device 10 for extinguishing birthday candles comprises a housing 12, a selectively operable fan 18 adapted to propel clean ambient air (that is, air that surrounds the device) away from the device and in the direction in which the device is being aimed, and a pressure switch 22 electrically connected to the fan 18 such that the fan 18 operates when the pressure switch 22 is activated. The housing 12 defines an air chamber 40 and an air inlet 14. The air chamber 40 is adapted to receive exhaled breath from a user (indicated by the arrow on the left side of FIG. 2) via the air inlet 14 (i.e., the user places his/her lips around the air inlet and blows into the air inlet). The pressure switch 22 is adapted to be activated by the exhaled breath such that the exhaled breath causes the fan 18 to operate. The rotation of the fan 18 is indicated by the curved arrows in FIG. 2, while the propelled ambient air is indicated by the wavy arrows in FIG. 2. In the illustrated embodiment, the housing 12 is elongated and generally tubular, however any suitable shape may be used.

Importantly, the housing further comprises an exhaust housing 16 that defines an air outlet 44. The air outlet 44 enables the user's exhaled breath to be exhausted from the air chamber 40 in a direction away from the candles/cake. In the illustrated embodiment, the user's exhaled breath enters the air chamber 40 via the air inlet 14 and exits the air chamber 40 through port 42 into the air outlet 44 and exits the device via the exhaust housing 16 toward the user, as indicated by the dashed line arrow in FIG. 2. Any other suitable air outlet structure (e.g., one or more angled holes defined in the housing) may be used to exhaust the user's exhaled air in any suitable direction except toward the candles/cake.

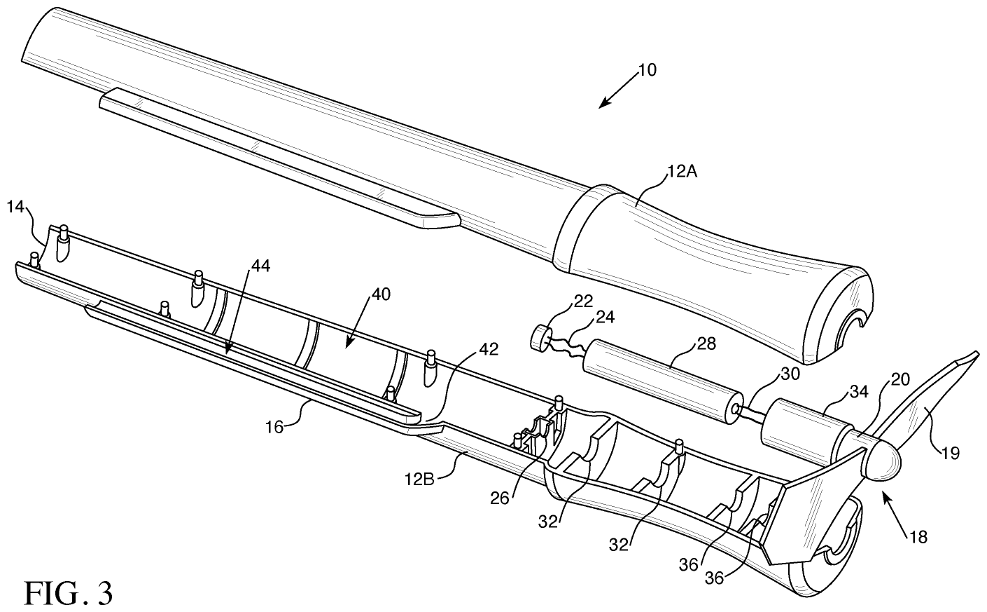

In the illustrated embodiment, the housing 12 comprises an upper portion 12A and a lower portion 12B that are substantially mirror-image and that mate securely using any suitable attachment mechanism/method to form the housing. The housing 12 may be constructed of any suitable material, such as any suitable plastic. As seen in FIG. 3, the housing houses the pressure switch 22 electrically connected via wiring 24 to a battery 28 (or any other suitable power source for the fan). The battery 28 may comprise any suitable type and number of batteries and may be rechargeable. The battery 28 is electrically connected via wiring 30 to the fan 18. The fan 18 comprises a fan motor 34 that selectively rotates a hub 20 and one or more fan blades 19 affixed to or integral with the rotatable hub. Any suitable type and size of fan and fan motor may be used. While the illustrated embodiment shows very simple electrical connections/circuitry, alternative embodiments of the invention may include more complex electrical circuitry to provide improved and/or additional functionality (e.g., a voltage regulator (not illustrated) may be included).

A mounting wall 26 (the lower half of which is integral with the lower portion 12B and is seen in FIG. 3, while the mirror-image upper half is integral with the upper portion 12A and is not visible in the figures) holds the pressure switch 22 in position such that the pressure switch 22 is at least partially positioned within the air chamber 40 or at least exposed to the exhaled breath within the air chamber 40. The mounting wall 26 also provides a barrier which deflects the exhaled breath within the air chamber 40 back toward the air outlet 44. Two mounting walls 32 (the lower halves of which are integral with the lower portion 12B and are seen in FIG. 3, while the mirror-image upper halves are integral with the upper portion 12A and are not visible in the figures) support the battery 28. Two mounting walls 36 (the lower halves of which are integral with the lower portion 12B and are seen in FIG. 3, while the mirror-image upper halves are integral with the upper portion 12A and are not visible in the figures) support the fan motor 34. Any other suitable mounting mechanism/method may be used for the pressure switch, the battery, and/or the fan.

The pressure switch 22 (also termed a pressure sensor switch) is activated by the air pressure created when the celebrant blows into the device 10. In one embodiment, this switch utilizes similar technology to the pressure sensor switches often used in e-cigarette devices. Whereas an e-cigarette application detects a suck of air to switch on its heating coil, that same switch can be turned around in the channel of air flow to detect an expressed puff of air. In this embodiment, the pressure sensor switch would detect the pressure differential created by a puff of breath and thereby switch on to deliver current for the fan 18. In another embodiment (not illustrated), the pressure sensor switch comprises a mechanism whereby the celebrant's expelled breath actuates a movable flap, lid, diaphragm, or slug of material so as to contact and actuate a switch.

In the illustrated embodiment, the hub 20 of the fan 18 protrudes through the end of the housing 12 such that the fan blades 18 are not enclosed by the housing 12. In alternative embodiments (not illustrated), the fan blade(s) may be enclosed by the housing. For example, the distal end of the housing may be an open-ended cone that surrounds the fan blade(s). In such an embodiment, vents or holes would be cut into the housing so as to allow ingestion of ambient air that the fan would propel onto the candle.

Alternative embodiments of the invention (not illustrated) may include such enhancements as an internal whistle or other noisemaker 46 that is also activated by the celebrant's breath, external LEDs 48 to increase the celebratory effect, and/or placement of images and text around the outside of the housing. In alternative embodiments of the invention (not illustrated), the fan blade(s) may include LED lights and the required circuitry to allow the LEDs to illuminate in pre-programmed patterns on the blades of the fan as those blades spin.

In use, the birthday celebrant will hold the device to his/her mouth, aim the device toward the lit birthday candles, and blow into the air inlet. The blown air is directed out of the device and away from the birthday cake as it actuates the air pressure sensor switch and activates the fan. The fan propels clean ambient air outwards over the birthday candles to extinguish them. While embodiments of the invention are described herein for use in extinguishing birthday candles, embodiments of the invention may be used with other types of candles or for purposes other than extinguishing candles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A device for extinguishing birthday candles comprising:
a housing defining an air chamber and further defining an air inlet, wherein the air chamber is adapted to receive exhaled breath from a user via the air inlet;
a selectively operable fan at least partially positioned within the housing and adapted to propel ambient air away from the device; and
a pressure switch positioned within the housing and electrically connected to the fan such that the fan operates when the pressure switch is activated, wherein the pressure switch is adapted to be activated by the exhaled breath such that the exhaled breath causes the fan to operate.

2. The device of claim 1, wherein the pressure switch is positioned within the air chamber.

3. The device of claim 1, wherein the housing defines an air outlet adapted to exhaust the exhaled breath from the air chamber.

4. The device of claim 3, wherein the air outlet is adapted to exhaust the exhaled breath from the air chamber at an angle relative to the propelled ambient air.

5. The device of claim 3, wherein the air outlet is adapted to exhaust the exhaled breath from the air chamber in a direction opposite that of the propelled ambient air.

6. The device of claim 3, wherein the air outlet is adapted to exhaust the exhaled breath from the air chamber in a direction toward the user.

7. The device of claim 1, wherein the fan comprises at least one rotatable fan blade and a motor connected to the at least one rotatable fan blade such that the at least one rotatable fan blade rotates when the motor is activated.

8. The device of claim 7, wherein the at least one rotatable fan blade is external to the housing.

9. The device of claim 1, wherein the housing is elongated.

10. The device of claim 9, wherein the housing is generally tubular.

11. The device of claim 1, further comprising a noisemaker adapted to selectively emit a noise when the exhaled breath is received in the air chamber.

12. The device of claim 11, wherein the noisemaker is mechanical or electronic.

13. The device of claim 1, further comprising a light adapted to selectively emit light when the exhaled breath is received in the air chamber.

14. The device of claim 13, wherein the light comprises at least one light emitting diode.
